(19) United States
(12) Patent Application Publication
(10) Pub. No.: US 2004/0002896 A1
(43) Pub. Date: Jan. 1, 2004

(54) Collection of behavior data on a broadcast data network

(76) Inventors: Jenni Alanen, Tampere (FI); Juha-Pekka Luoma, Tampere (FI); Holger Hussmann, Tampere (FI)

Correspondence Address: MORGAN & FINNEGAN, L.L.P., 345 Park Avenue, New York, NY, 10154-0053, US

(21) Appl. No.: 10/183,646

(22) Filed: Jun. 28, 2002

(51) Int. Cl. G06F 17/60

(52) U.S. Cl. 705/14

(57) ABSTRACT

A method, system, and computer program product for collecting usage data to assist an advertiser with a targeted marketing activity wherein the advertiser accesses the usage data to determine an appropriate advertisement for a second user. The method comprises receiving a data resource from a communications network, storing the data resource, displaying the data resource for a first user, extracting usage data that relates a characteristic of the first user to a characteristic of the data resource, and storing the usage data. The method may further comprise requesting the data resource.

### FIELD OF THE INVENTION

The invention disclosed herein is a method, system, and computer program product for collecting targeted marketing usage data from a communications network. The method, system, and computer program product monitors a broadcast data network to collect behavior data for a user that will assist an advertiser with a targeted marketing activity.

### BACKGROUND OF THE INVENTION

Digital Video Broadcasting (DVB) is an open standard that applies to digital transmission of a television signal. DVB employs a Moving Picture Experts Group (MPEG) compression algorithm such as MPEG-2 to digitally store the video and audio components of the television signal. DVB sub-standards address satellite (DVB-S), cable (DVB-C), and terrestrial (DVB-T) transmission of channel signals. In addition, DVB addresses the transmission of system information, a program guide, and a scrambling system that protects the signal. A typical DVB data stream includes television broadcasting, streaming video, real-time music streaming, content downloads such as electronic books and newspapers, electronic commerce actions, mobile telephony data, and Internet Protocol (IP) data such as web browsing.

Web advertisers traditionally examine the number of “hits” a web page receives to decide whether to invest in advertising on a particular web page. Broadcast media advertisers, on the other hand, traditionally rely upon user behavior and demographic statistics to target a particular segment of the population. The advent of DVB services make it necessary for web advertisers to consider targeted marketing initiatives.

The prior art targeted marketing systems collect usage data from an Internet-based network or a television broadcast. For the Internet-based network, the prior art systems calculate the usage for a user by recording the number of times a user “hits” a web page, that is, the number of times a user requests a particular web page. For the television broadcast, the prior art systems collect usage data on a per household basis from a selected few households using viewer questionnaires and channel counters. In both the Internet-based network and the television network, the results depend upon the demographics of the chosen sample and do not accurately reveal the actual usage.

The UBA differs from the prior art because it calculates the usage of services that content providers broadcast or push to a customer, as well as the services that the customer request. In addition, UBA is not limited to collecting WWW usage statistics and also collects streaming media and data carousel usage statistics. Even though the UBA collects data from various broadcast networks and services, it is also useful in hybrid networks (i.e., a network that carries unidirectional broadcast data as well as bi-directional Internet data) and may filter the content and service selection for a user. Since an exemplary implementation of the UBA is as a web browser application, it is a generic solution and transparent to the client software.

Thus, there is a need for a method, system, and computer program product for collecting usage data to assist an advertiser with a targeted marketing activity. An advertiser may maximize the power of an advertisement by analyzing the usage data and focusing future advertisements to a particular segment of the user population. The method, system, and computer program product for collecting usage data disclosed herein addresses this need.

### SUMMARY OF THE INVENTION

A method, system, and computer program product for collecting usage data to assist an advertiser with a targeted marketing activity wherein the advertiser accesses the usage data to determine an appropriate advertisement for a second user. The method comprises receiving a data resource from a communications network, storing the data resource, displaying the data resource for a first user, extracting usage data that relates a characteristic of the first user to a characteristic of the data resource, and storing the usage data. The method may further comprise requesting the data resource.

The communications network in the method, system, and computer program product includes either a broadcast data network or a hybrid network. If the communications network is a hybrid network, it includes broadcast data and Internet data. Broadcast data includes television broadcast data digital video broadcast data, streaming video data, video-on-demand data, or near video-on-demand data. Internet data includes web page data, software download data, digital image data, music download data, video download data, radio station data, real-time music streaming, multimedia content data for books, magazines, or newspapers, or electronic commerce data.

The method, system, and computer program product may further comprise creating a profile for a user, and storing the profile, wherein the profile includes at least one content filtering requirement. The data resource satisfying said at least one content filtering requirement that includes at least one content category type. The method, system, and computer program product may further comprise uploading the profile from the client computer to a server computer connected to the client computer, and monitoring the communications network for said at least one content filtering requirement. The creating of the profile may further comprise providing demographic data for the user, and either selecting at least one content category type for the user to receive or selecting at least one content category type for the user to not receive.

In another embodiment, the method comprises storing at least one content filtering requirement for a first user, monitoring a communications network for a data resource that satisfies said at least one content filtering requirement, storing the data resource, displaying the data resource for a first user, extracting usage data that relates a characteristic of the first user to a characteristic of the data resource, and storing the usage data. In this embodiment, the advertiser accesses the usage data to determine an appropriate advertisement for a second user. The method may further comprise comparing a content category type for the data resource to said at least one content category type.

### BRIEF DESCRIPTION OF THE DRAWINGS

The accompanying figures best illustrate the details of the method, system, and computer program product for collecting usage data, both as to its structure and operation. Like reference numbers and designations in these figures refer to like elements.

FIG. 1 is a network diagram that illustrates an operating environment of a system for collecting usage data from a broadcast data network.

FIG. 2A expands upon the network diagram shown in FIG. 1 to illustrate the hardware and software components that comprise client computer 110 and server computer 150.

FIG. 2B is a network diagram that illustrates, in greater detail, the hardware and software components that comprise UBA client 220 as shown in FIG. 2A.

FIG. 2C is a network diagram that illustrates, in greater detail, the hardware and software components that comprise UBA server 260 as shown in FIG. 2A.

### DETAILED DESCRIPTION OF THE INVENTION

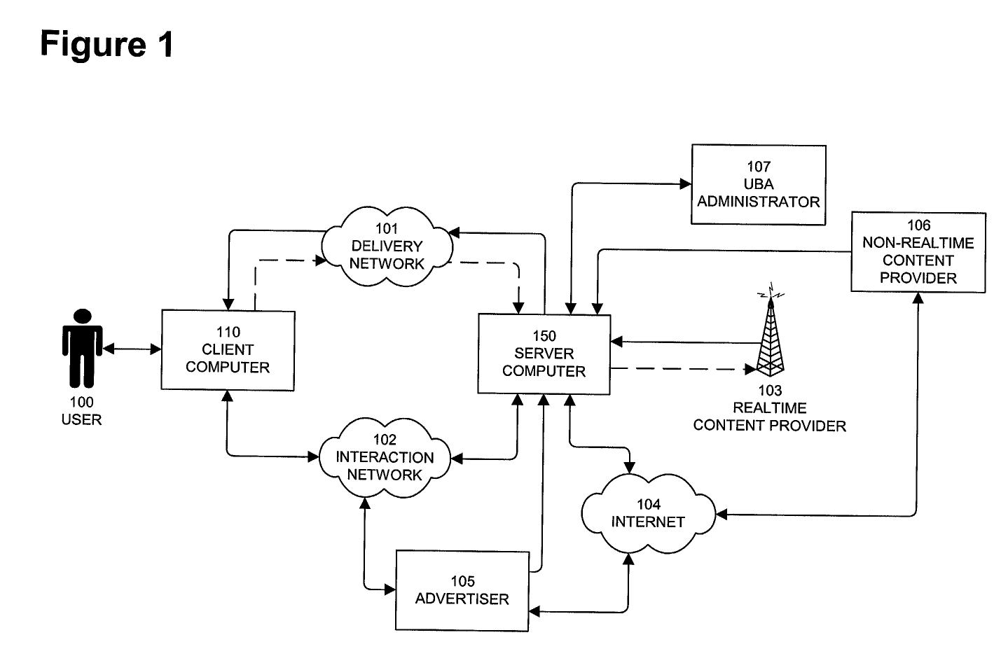

FIG. 1 is a network diagram that illustrates an operating environment of a system for collecting usage data from a broadcast data network. Delivery network 101, interaction network 102, and Internet 104, as shown in FIG. 1, are public communication networks that support broadcast delivery of data packets, in general, and broadcast delivery of Internet protocol (IP) data packets, in particular. The invention disclosed herein also contemplates network architectures comparable to delivery network 101, interaction network 102, and Internet 104. Comparable network architectures include a public switched telephone network, a digital video broadcasting (DVB) network, a wireless network, and a private network. A wireless network includes a cellular network and a satellite network. A private network includes a local area network, a personal area network such as a Bluetooth network, an intranet, and an extranet. An intranet is a private communication network that provides an organization, such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The invention disclosed herein also contemplates network protocols such as Ethernet, Token Ring, and proprietary network protocols comparable to the Internet protocol.

Referring again to FIG. 1, client computer 110 is a general-purpose client computer and server computer 150 is a general-purpose server computer. In one embodiment, non-real-time content provider 106 transmits content data to server computer 150 via a secure connection over an Internet Protocol (IP) based network such as Internet 104. The transmission of the content data by non-real-time content provider 106 may be solicited from user 100, client computer 110, or server computer 150 or unsolicited. For the solicited transmission, non-real-time content provider 106 transmits the content data in response to a request for the content data. For the unsolicited transmission, non-real-time content provider 106 transmits the content data when it is available for transmission. In another embodiment, real-time content provider 103 transmits content data to server computer 150 via a secure connection over an IP based network such as Internet 104. In yet another embodiment, the communication connection between server computer 150 and real-time content provider 103 is a bi-directional connection. In this embodiment, the communication connection transmits request messages from user 100, client computer 110, or server computer 150. Advertiser 105 transmits advertisement data to server computer 150 via a secure connection over an IP based network such as Internet 104. Server computer 150 stores the content data and the advertisement data. User 100 operates client computer 110 to send a request for content data to server computer 150 via interaction network 102. In response to the request, client computer 110 receives a broadcast data stream from server computer 150 via delivery network 101. The broadcast data stream includes synchronized content data and advertisement data. Interaction network 102 is a bi-directional network such as a public switched telephone network (PSTN), integrated services digital network (ISDN), global system for mobile communications (GSM), universal mobile telecommunications system (UMTS), or the equivalent. Delivery network 101 is a unidirectional network such as a digital video broadcasting (DVB) network or the equivalent. In addition, delivery network 101 may include broadcast networks that utilize a PSTN, ISDN, GSM, UMTS, or the equivalent.

The content data that content provider 106 transmits includes World Wide Web (WWW) browsing data, television broadcast data, and electronic commerce data. WWW browsing data includes software downloads such as standalone programs, Java applets, JavaScript programs, and common gateway interface (CGI) programs. WWW browsing data also includes audio and video downloads such as MP3, WAV, and MOV files, digital photographs such as JPEG, GIF, and TIFF files and other still images, real-time music data streaming, and web page interaction using the hypertext markup language (HTML) and extensible markup language (XML). Television broadcast data includes streaming video, video on-demand (VOD), and near video on-demand (NVOD). Electronic commerce data includes media purchases such as books and newspapers, and consumer purchases.

The advertisement data that advertiser 105 transmits includes WWW, broadcast, and print media advertisements. WWW advertisements include HTML and XML advertisements such as banner and pop-up advertisements. Broadcast advertisements include traditional television and radio advertisements transmitted via a broadcast data network. Print media advertisements include digital magazine and newspaper subscriptions and e-mail advertisements transmitted via a broadcast data network.

The behavior data collected for user 100 helps advertiser 105 focus the advertisement data to a specific target demographic audience by identifying either an audience that is likely to show an interest in the advertisement or an audience that has shown an interest in the advertisement. If the target demographic audience for an advertisement is males between the ages of 18 and 35, a network service that is requested by a user in that segment of the population will likely generate interest in the advertisement. Alternatively, an advertiser may want to directly market any user who demonstrates an interest in an advertisement over the next 30 days. Since the behavior data is personal to user 100, user 100 and the owner of the UBA data must enter into an agreement before the owner releases the behavior data. In one embodiment, user 100 enters into an agreement with the owner of the UBA data as a result of a voluntary registration process that compensates user 100 by providing a discount or coupon in exchange for the behavior data. As a result of the registration process, the UBA creates a profile for user 100 that includes personal data such as the name, street address, telephone number, or electronic mail address of user 100. If user 100 demonstrates an interest in the advertiser's advertisement over the next 30 days, the UBA will pass the behavior data for user 100 to the advertiser for direct marketing.

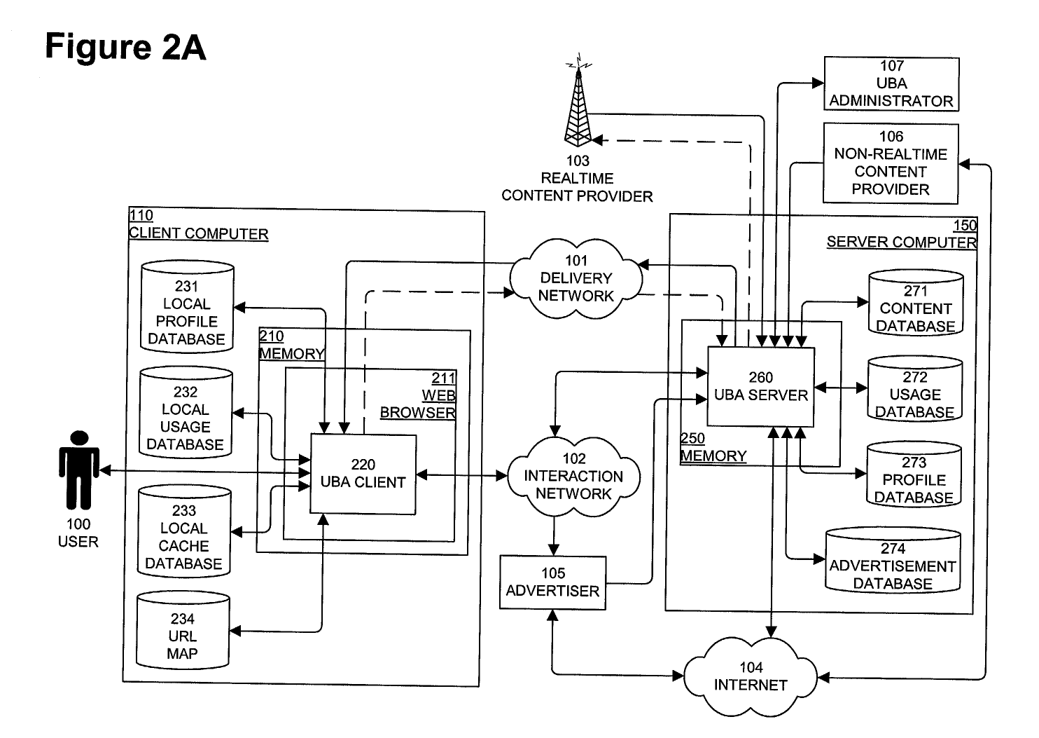

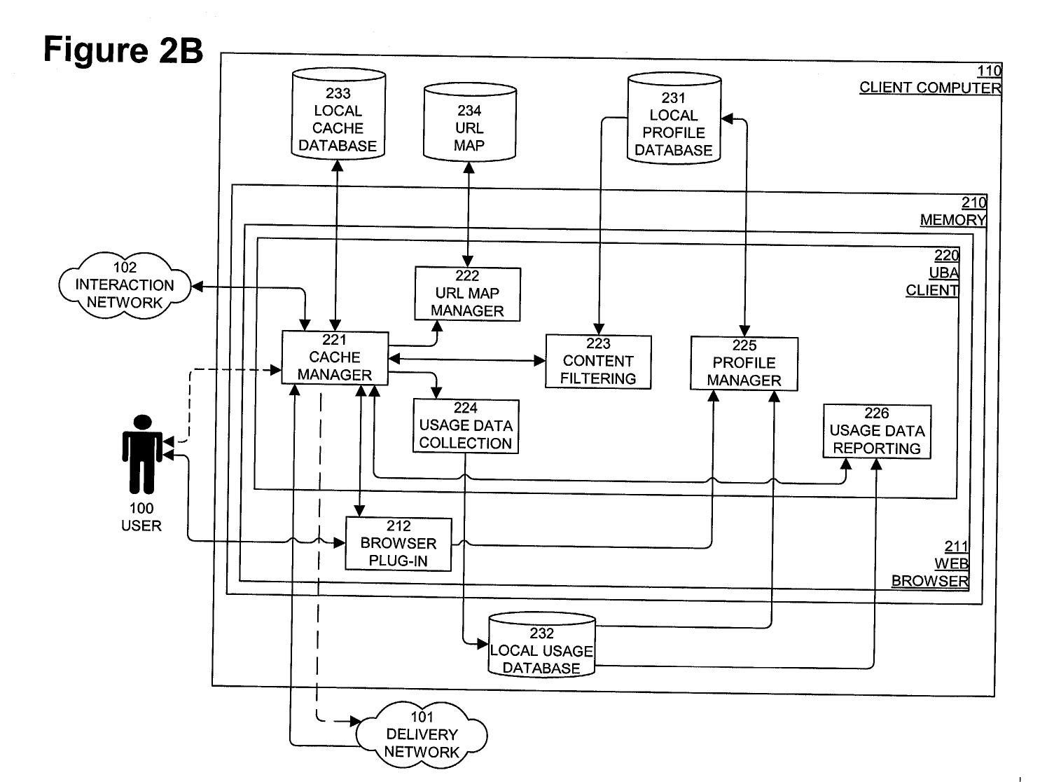

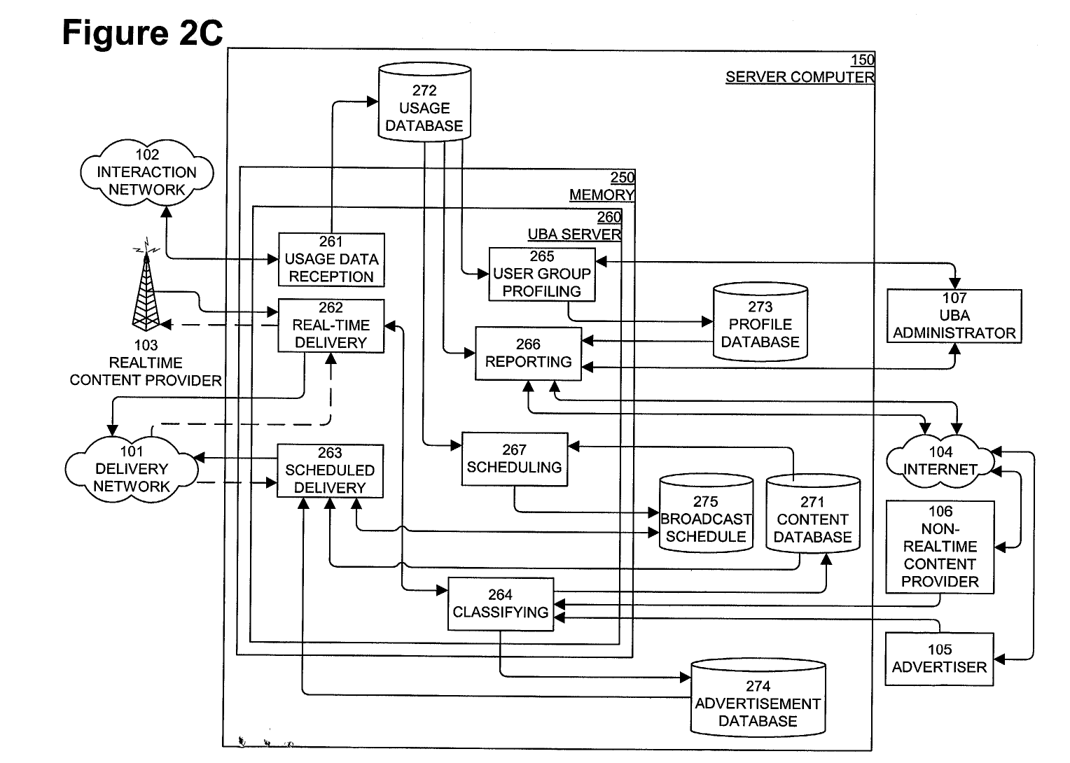

FIG. 2A expands upon the network diagram shown in FIG. 1 to illustrate the hardware and software components that comprise client computer 110 and server computer 150. Even though FIG. 2A illustrates the system as a distributed architecture, one skilled in the art will realize that another embodiment is to integrate the functions performed by client computer 110 and server computer 150 into a single general-purpose computer.

Client computer 110 as shown in FIG. 2A is a general-purpose computer comprising memory 210, a processor (not shown), and data storage. The data storage includes local profile database 231, local usage database 232, local cache database 233, and uniform resource locator (URL) map 234. A bus (not shown) is the communication medium for client computer 110 that connects memory 210, the processor (not shown), and the data storage. FIG. 2A illustrates the data storage for client computer 110 as separate physical devices however, one skilled in the art will realize that another embodiment is to store the data in a single physical device that includes a separate logical partition for each type of data illustrated in FIG. 2A. FIG. 2A also illustrates the data storage for client computer 110 as internal devices however, one skilled in the art will realize that another embodiment is for the data storage to be external to client computer 110 and accessible via a network connection. The configuration of memory 210 includes computer programs such as web browser 211 and user behavior agent (UBA) client 220. Web browser 211 is a general-purpose hypertext transfer protocol (HTTP) web browser such as Netscape Communicator, Microsoft Internet Explorer, or Mosaic. FIG. 2A illustrates UBA client 220 as a plug-in component to web browser 211 however, one skilled in the art will realize that another embodiment is for UBA client 220 to be separately resident in memory 210 and communicate with web browser 211 via an interprocess communication mechanism. User 100 communicates with delivery network 101 and interaction network 102 via UBA client 220. UBA client 220 communicates with UBA server 260 of server computer 150 via delivery network 101 and interaction network 102.

Server computer 150 as shown in FIG. 2A is a general-purpose server computer comprising memory 250, a processor (not shown), and data storage. The data storage includes content database 271, usage database 272, profile database 273, and advertisement database 274. A bus (not shown) is the communication medium for server computer 150 that connects memory 250, the processor (not shown), and the data storage. FIG. 2A illustrates the data storage for server computer 150 as separate physical devices however, one skilled in the art will realize that another embodiment is to store the data in a single physical device that includes a separate logical partition for each type of data illustrated in FIG. 2A. FIG. 2A also illustrates the data storage for server computer 150 as internal devices however, one skilled in the art will realize that another embodiment is for the data storage to be external to server computer 150 and accessible via a network connection. The configuration of memory 250 includes computer programs such as UBA server 260. UBA server 260 communicates with real-time content provider 103, advertiser 105, non-real-time content provider 106, and UBA administrator 107. UBA server 260 also communicates with advertiser 105 and non-real-time content provider 106 via Internet 104. UBA server 260 communicates with UBA client 220 of client computer 110 via delivery network 101 and interaction network 102.

FIG. 2B is a network diagram that illustrates, in greater detail, the hardware and software components that comprise UBA client 220 as shown in FIG. 2A. UBA client 220 further comprises cache manager 221, URL map manager 222, content filtering 223, usage data collection 224, profile manager 225, and usage data reporting 226. Web browser 211 further comprises browser plug-in 212.

User 100 communicates with cache manager 221 via browser plug-in 212 of web browser 211. Optionally, user 100 communicates directly with cache manager 221. Cache manager 221 receives a content data from delivery network 101. Cache manager 221 also receives subscription request data and content data from interaction network 102. The terms content data or resource as used herein refer to content data or a multimedia content file received over a network connection using a protocol such as hypertext transfer protocol (HTTP), unidirectional hypertext transfer protocol (UHTTP), file transfer protocol (FTP), or the equivalent.

Depending upon the subscription request data, cache manager 221 periodically monitors a connection on either delivery network 101 or interaction network 102 to receive a resource such as an update to a specified World-Wide-Web (WWW) page. Cache manager 221 uses HTTP to emulate a normal HTTP cache when communicating with client software however, the client configuration must post all HTTP requests through the cache using, for example, the standard “HTTP proxy” setting in a web browser. If cache manager 221 includes an HTTP cache to store resources received over the delivery network 101, cache manager 221 will also operate as a normal HTTP cache for any data received via interaction network 102.

Content data that cache manager 221 receives via delivery network 101 using a protocol such as UHTTP or DVB data/object carousels may not be available via interaction network 102. Content data that is not available via interaction network 102 typically is not associated with an HTTP or FTP URL. Instead, cache manager 221 uniquely identifies a resource by employing a broadcast URL scheme such as the local identifier URL scheme (LID) (see Advanced Television Enhancement Forum (ATVEF) Enhanced Content Specification, 2000, http://www.atvef.com/library/ATVEF%20spec1_{—}1a_Final.pdf) or DVB (see Digital Video Broadcasting Multimedia Home Platform, version 1.0.2, DVB BlueBook A057 Rev. 2, Feb. 26, 2002, http://www.mhp.org/technical_essen/pdf_and_other_files/a057r2.pdf). However, standard client software web browsers such as Netscape and Internet Explorer do not support these URL types. The system described herein includes the translation of the broadcast URL for a received resource into a unique HTTP URL on client computer 110.

After receiving a resource, cache manager 221 communicates with content filtering 223 to determine whether the resource meets the requirements specified in the profile for user 100. If the resource meets the requirements specified by user 100, cache manager 221 stores the resource in local cache database 233. In one embodiment, the content filters compare the profile for user 100 stored in local profile database 231 to the content description available for the received resource. The profile for user 100 includes characteristics that describe how user 100 uses the content data. The characteristics include demographic data that describe user 100, the type of content, how long user 100 accessed the content, or whether user 100 examined any advertisement associated with the content. In another embodiment, content filtering 223 descrambles the resource before applying the content filters and returns the descrambled resource to cache manager 221 for storage in local cache database 233.

Prior to storing the resource in local cache database 233, cache manager 221 communicates with URL map manager 222 to assign an HTTP URL to the resource. URL map manager 222 converts a broadcast URL to an HTTP URL and stores the mapping, that is, a tuple of the two URLs, in URL map 234. URL map manager 222 also periodically analyzes URL map 234 to remove from the database any mappings for a resource that is no longer in local cache database 233.

As shown in FIG. 2B, the implementation of URL map manager 222 includes modified HTTP cache software. In another embodiment, URL map manager 222 may be a separate program or process that connects with an unmodified HTTP cache or HTTP server. If URL conversion is necessary at the client, the installation of the web browser client will then include plug-in components for different broadcast URLs. The plug-in components would retrieve the HTTP URL corresponding to a broadcast URL from the database. The plug-in component or the actual web browser software would then retrieve the corresponding resource from the HTTP cache or server. In addition, the plug-in components could control the reception of unidirectional data such as tuning to a particular DVB transport stream.

UBA client 220 collects usage data for user 100. After receiving a resource, cache manager 221 communicates with usage data collection 224 to retrieve the metadata (i.e., data that describes data) associated with the resource. The metadata includes a classification type for the content, a group description for targeted advertising, or the equivalent. There are several alternative ways for the broadcast operator to deliver the metadata cache manager 221. First, the broadcast operator may append the metadata to the URL that identifies the resource. Second, the broadcast operator may insert the metadata into an extensible markup language (XML) or HTML resource using meta tags such as those defined in the W3C's PICS and RDF frameworks. Third, the broadcast operator may transmit the metadata when announcing a streaming media resource by defining extensions to SAP/SDP announcements for the metadata. Usage data collection 224 parses the usage data from the resource and stores the usage data and an identifier for user 100 in local usage database 232.

The usage data collected includes delivery type, content descriptions, Internet data, quality-of-service (QOS) data, user detail data, and location data. The delivery type further includes cached content, audio streaming, video streaming, package delivery, and real-time data streaming. The content descriptions further include bandwidth usage, content size, downloading time, streaming time, and duration. The Internet data further includes URLs, usage of additional information of broadcast (e.g., WWW links in streaming data), and usage of cached content. The QOS data further includes the number of successful connections and the number of attempted connections. The user detail data further includes ordering behavior (e.g., how far in advance and how often), billing behavior, billing amount, and user claims. The location information further includes content location and user location. The UBA is beneficial to a data broadcast operator because the operator may optimize the content to suit the user requirements, better allocate bandwidth and pricing. Thus, the UBA may improve the popularity of a site.

UBA client 220 also delivers a usage data report for user 100 to interaction network 102. UBA server 260 typically generates the request for the usage data report however, in another embodiment, user 100 may also generate the request. Cache manager 221 communicates with usage data reporting 226 to retrieve the usage data for user 100 from local usage database 232. Usage data reporting 226 formats the usage data and transmit the report. Cache manager 221 periodically uploads the data in local usage database 232 to server computer 150 for storage in usage database 272.

To receive a resource via UBA client 220, user 100 sends a request to web browser 211 to download the resource identified by a URL from UBA server 260 and display the resource. Cache manager 221 acts as a proxy and retrieves the resource on behalf of web browser 211. If the resource is available in local cache database 233, cache manager 221 immediately retrieves the resource and delivers the resource to web browser 211. If the resource is not available in local cache database 233, cache manager 221 communicates with content filtering 223 to configure the content filters for user 100 and contacts server computer 150 via interaction network 102 and UBA server 260 to retrieve the resource from content database 271. UBA server 260 returns the resource to UBA cache manager 221 via delivery network 101, however cache manager 221 may also retrieve the resource via interaction network 102. When cache manager 221 receives the resource, it checks the category of the resource and stores the details of the content request as usage data. Cache manager 221 periodically uploads the usage data to UBA server 260. The details of the content request include the content category, content provider identifier, size of the resource, time of day for the download, hit ratio for the cache, current URL, previous URL, or the equivalent. If the resource is not available from content database 271, cache manager 221 will return the expired resource to web browser 211 with an HTTP stale resource warning.

To edit a profile in local profile database 231 for user 100, user 100 communicates with profile manager 225 via browser plug-in 212 of web browser 211. Each profile in local profile database 231 defines the content categories that user 100 wants to receive, as well as the content categories that user 100 does not want to receive. In addition, UBA client 220 may change the profile for user 100 according to a particular browsing behavior. In another embodiment, UBA client 220 does not modify the profile edited by user 100, but instead maintains a separate profile for user 100. Cache manager 221 periodically uploads the data in local profile database 231 to server computer 150 for storage in profile database 273.

To receive content associated with a resource, cache manager 221 continues to receive content in the background after receiving the resource. For example, if the resource is a HTML page, cache manager 221 will receive the HTML page and begin processing the HTML page while continuing to receive the associated resources included as links on the HTML page. If the resource passes the content filters, the associated resources are also stored in local cache database 233, but are linked to the resource. If the resource does not pass the content filters, cache manager 221 stops receiving the associated resources and removes any associated resources receiving in the interim.

To maintain the profile for user 100, cache manager 221 communicates with profile manager 225 to update the profile for user 100 when a resource matches the profile. Thus, the profile for user 100 will contain distribution data for the user's content requests among the various content categories. In addition, the profile for user 100 may include demographic data.

To upload usage data to UBA server 260 requires the consent of user 100. If user 100 consents to uploading the usage data, cache manager 221 transmits the accumulated usage data to UBA server 260 via a secure connection such as a secure IP connection. The upload does not occur with any particular regularity. For example, the upload may occur when UBA client 220 detects that user 100 has set up a connection via interaction network 102 and local usage database 232 includes “enough” data. The uploaded data includes the number of content requests that user 100 has made for each content category and each content provider, the URLs of selected “key resources” requested by user 100, and demographic data. There are several alternative ways to associate the uploaded usage data with user 100. First, if user 100 completed the UBA registration process, the uploaded usage data may include the unique identifier assigned to user 100 during the registration process. This alternative allows the usage data of a registered user to always be associated with user 100. Second, since a semi-permanent identifier exists for each user 100, the uploaded usage data may include the semi-permanent identifier similar to the process of sending a “cookie” to a web browser. This alternative allows the usage data to be associated with the same user across multiple, if not every, upload session. Third, the uploaded usage data may be anonymous. This alternative only allows the usage data to be consistent with a single upload session, but still provides valuable information on the behavior of user groups and individual user.

To classify the profile for user 100, cache manager 221 sends a request UBA server 260 to associate the profile with one or more user group profiles. UBA server 260 maintains the list of user group profiles. This may occur, for example, after cache manager 221 uploads the usage data to UBA server 260. This classification allows content filtering 223 to filter out any advertisements that do not target a matching user group profile. In one embodiment, cache manager 221 periodically updates the user group information to retrieve any changes in the user group profiles. In an alternate embodiment, UBA server 260 may match user 100 to one or more predefined profiles and download the identifier for each profile to the corresponding UBA client 220. For example, if the usage data indicates that user 100 is a soccer fan and lives in Boston, UBA server 260 will send the profile identifier for the “soccer fan” profile and the profile identifier for the “Boston resident” profile to the UBA client 220 for user 100. The download of the profile identifiers may occur via interaction network 102 following the upload of usage data or via delivery network 101. UBA server 260 inserts profile identifiers into advertisements and content items to facilitate targeted advertisement and content filtering by UBA client 220.

FIG. 2C is a network diagram that illustrates, in greater detail, the hardware and software components that comprise UBA server 260 as shown in FIG. 2A. UBA server 260 further comprises usage data reception 261, real-time delivery 262, scheduled delivery 263, classifying 264, user group profiling 265, reporting 266, and scheduling 267.

Advertiser 105 and non-real-time content provider 106 initiate the processing performed by UBA server 260. Classifying 264 receives content data from non-real-time content provider 106 and advertising data from advertiser 105. Classifying 264 associates a classification with each content data item and advertisement data item and stores the content data in content database 271 and the advertisement data in advertisement database 274. The classification for content data may include the identity of non-real-time content provider 106 or advertiser 105, a rating from an external content rating service, keywords contained in the data, or the equivalent. The classification for a resource may include the identity of non-real-time content provider 106 or advertiser 105, a category type such as music, news, or sports, an integer weight indicating the relevance of the resource, or the equivalent. In another embodiment, the classification for the resource includes more than one category type. To minimize the storage required for the usage data, only the content category and content provider identifier are stored for a browsed resource. However, UBA client 220 may classify some resources as “key” resources and track the resource individually when user 100 accesses it with a web browser.

Real-time content provider 103 may transmit a real-time stream of content data to real-time delivery 262. Real-time delivery 262 communicates the data stream to classifying 264 for classification and transmits the content data to UBA client 220 via delivery network 101. Optionally, real-time delivery 262 responds to the transmissions sent by real-time content provider 103 and may receive responses from delivery network 101. The broadcast network operator receives content data streams from UBA server 260 via a secure connection. In another embodiment, UBA server 260 multiplexes content data streams with other broadcast content such as normal television programming before forwarding the received data to a broadcast network. The broadcast network operator may request a report from UBA server 260 concerning data traffic forwarded to the delivery network 101. The report may contain information such as the traffic distribution among content providers and content category types. This information is useful to the broadcast network operator when conducting network planning and billing.

Scheduled delivery 263 controls the delivery of content data that UBA server 260 does not receive from real-time content provider 103. Scheduled delivery 263 identifies the resources for delivery, retrieves the resources from content database 271, and prepares a schedule for the delivery and stores the schedule in broadcast schedule 275. Scheduled delivery 263 also identifies the advertisement data stored in advertisement database 274 that shares the same content category classification as the resources. Scheduled delivery 263 synchronizes the content data and advertisement data and transmits the synchronized data stream to delivery network 101. Optionally, scheduled delivery 263 receives responses from delivery network 101. If the delivery involves a resource that does not require real-time delivery such as a software download, scheduled delivery 263 will schedule the resource multiple times to recover from errors in unidirectional data reception. Scheduled delivery 263 also takes bandwidth limitations into consideration when scheduling the delivery.

Usage data reception 261 receives the usage data uploaded by cache manager 221 of UBA client 220 via interaction network 102. Usage data reception 261 stores the uploaded usage data in usage database 272. User group profiling 265, reporting 266, and scheduling 267 retrieve usage data from usage database 272 for subsequent processing.

UBA administrator 107 communicates with user group profiling 265 to create, maintain, and delete a profile for user 100 in profile database 273. Adding a user group profile to UBA server 260 requires defining the usage parameters for the group including demographic data such as the age, occupation, race, gender, marital status, geographic location, level of education, and the equivalent. The definition of the user group profile also includes the content category type associated with the group as well as a quotient value (i.e., percentage) to indicate the portion of users who originate most of the requests for content belonging to the content category type. In another embodiment, the definition of the user group profile includes more than one content category type and the types may be combined with logical operations such as “and,” “or,” and “not.” For example, a user group profile defined by the usage parameters “(sports, 15%) AND (travelling, 20%)” describes users belonging to both the 15% of people who are most active in browsing sports content and the 20% of people who are most active in browsing travelling related content. The creation of a user group profile by UBA administrator 107 triggers user group profiling 265 to assign a unique identifier to the user group profile, store the user group profile in profile database 273, and associate the unique identifier and the user group profile in profile database 273. For example, the group of people described above could be interested in advertisements for sport-oriented vacations.

UBA administrator 107 also communicates with reporting 266 to request reports describing the usage data in usage database 272 and the profile data in profile database 273. UBA administrator 107 may perform a statistical analysis of the usage data to determine which profiles in a user group profile meet a particular pattern of content browsing and will likely benefit from targeted advertising. UBA administrator 107 may also request a report of service usage such as the distribution of requests among content category types and content providers.

Reporting 266 also sends similar reports upon request to non-real-time content provider 106 via Internet 104. If non-real-time content provider 106 and an operator of UBA server 260 cooperate, non-real-time content provider 106 may add a content category type to a resource. However, UBA server 260 will classify any content not classified by non-real-time content provider 106. Non-real-time content provider 106 sends the resources to UBA server 260 via a secure connection and, alternatively, may have a contract with UBA server 260 to upload the content to the server. Non-real-time content provider 106 may request information related to the user group profiles however, the statistical information provided in response must not compromise the privacy of user 100. Non-real-time content provider 106 may also request information concerning how the content usage by user 100 compares to the UBA user community such as the distribution of the requests among the content category types.

Reporting 266 also sends similar reports upon request to advertiser 105 via Internet 104. If advertiser 105 and an operator of UBA server 260 cooperate, advertiser 105 may add a content category type to an advertisement. However, UBA server 260 will classify any advertisement not classified by advertiser 105. Advertiser 105 sends the resources to UBA server 260 via a secure connection and, alternatively, may have a contract with UBA server 260 to upload advertisements to the server. Advertiser 105 may request information related to the user group profiles however, the statistical information provided in response must not compromise the privacy of user 100. Advertiser 105 may also request information concerning how the delivery and consumption of the advertisement data by user 100 compares to the UBA user community such as statistical information on users who followed links transmitted in an advertisement.

Scheduling 267 periodically retrieves usage data from usage database 272 to help determine the schedule stored in broadcast schedule 275.

Although the embodiments disclosed herein describe a filly functioning system, method, and computer program product for collecting usage data to assist an advertiser with a targeted marketing activity, the reader should understand that other equivalent embodiments exist. Since numerous modifications and variations will occur to those who review this disclosure, the system, method, and computer program product for collecting usage data to assist an advertiser with a targeted marketing activity is not limited to the exact construction and operation illustrated and disclosed herein. Accordingly, this disclosure intends all suitable modifications and equivalents to fall within the scope of the claims.

We claim:

1. A method for collecting usage data to assist an advertiser with a targeted marketing activity, comprising:
receiving a data resource from a communications network;
storing the data resource;
displaying the data resource for a first user;
extracting usage data that relates a characteristic of the first user to a characteristic of the data resource; and
storing the usage data,
wherein the advertiser accesses the usage data to determine an appropriate advertisement for a second user.

2. The method of claim 1, wherein the data resource is not requested by the first user.

3. The method of claim 1, further comprising:
requesting the data resource.

4. The method of claim 1, wherein the communications network is a broadcast data network.

5. The method of claim 1, wherein the communications network is a hybrid network.

6. The method of claim 5, wherein the hybrid network includes broadcast data and Internet data.

7. The method of claim 6, wherein the broadcast data includes television broadcast data.

8. The method of claim 7, wherein the television broadcast data includes digital video broadcast data, streaming video data, video-on-demand data, or near video-on-demand data.

9. The method of claim 6, wherein the Internet data includes web page data, software download data, digital image data, music download data, video download data, radio station data, real-time music streaming, multimedia content data for books, magazines, or newspapers, or electronic commerce data.

10. The method of claim 1, further comprising:
creating a profile for a user; and
storing the profile,
wherein the profile includes at least one content filtering requirement.

11. The method of claim 10, wherein the data resource satisfies said at least one content filtering requirement.

12. The method of claim 10, wherein said at least one content filtering requirement includes at least one content category type.

13. The method of claim 10, wherein the storing of the profile is on a client computer.

14. The method of claim 13, further comprising:
uploading the profile from the client computer to a server computer connected to the client computer; and
monitoring the communications network for said at least one content filtering requirement.

15. The method of claim 10, wherein the creating of the profile further comprises:
providing demographic data for the user; and
selecting at least one content category type for the user to receive.

16. The method of claim 10, wherein the creating of the profile further comprises:
providing demographic data for the user; and
selecting at least one content category type for the user to not receive.

17. The method of claim 1, wherein a multimedia viewer or a web browser displays the data resource.

18. The method of claim 1, wherein the characteristic of the first user includes identification data for the user.

19. The method of claim 1, wherein the characteristic of the data resource includes at least one content category type.

20. A system for collecting usage data to assist an advertiser with a targeted marketing activity, comprising:
a memory device; and
a processor disposed in communication with the memory device, the processor configured to:
receive a data resource from a communications network;
store the data resource;
display the data resource for a first user;
extract usage data that relates a characteristic of the first user to a characteristic of the data resource; and
store the usage data,
wherein the advertiser accesses the usage data to determine an appropriate advertisement for a second user.

21. The system of claim 20, wherein the data resource is not requested by the first user.

22. The system of claim 20, the processor further configured to:
request the data resource.

23. The system of claim 20, wherein the communications network is a broadcast data network.

24. The system of claim 20, wherein the communications network is a hybrid network.

25. The system of claim 24, wherein the hybrid network includes broadcast data and Internet data.

26. The system of claim 25, wherein the broadcast data includes television broadcast data.

27. The system of claim 26, wherein the television broadcast data includes digital video broadcast data, streaming video data, video-on-demand data, or near video-on-demand data.

28. The system of claim 25, wherein the Internet data includes web page data, software download data, digital image data, music download data, video download data, radio station data, real-time music streaming, multimedia content data for books, magazines, or newspapers, or electronic commerce data.

29. The system of claim 20, the processor further configured to:
create a profile for a user; and
store the profile,
wherein the profile includes at least one content filtering requirement.

30. The system of claim 29, wherein the data resource satisfies said at least one content filtering requirement.

31. The system of claim 29, wherein said at least one content filtering requirement includes at least one content category type.

32. The system of claim 29, wherein the processor stores the profile on a client computer.

33. The system of claim 32, the processor further configured to:
upload the profile from the client computer to a server computer connected to the client computer; and
monitor the communications network for said at least one content filtering requirement.

34. The system of claim 29, wherein to create the profile, the processor is further configured to:
provide demographic data for the user; and
select at least one content category type for the user to receive.

35. The system of claim 29, wherein to create the profile, the processor is further configured to:
provide demographic data for the user; and
select at least one content category type for the user to not receive.

36. The system of claim 20, wherein a multimedia viewer or a web browser displays the data resource.

37. The system of claim 20, wherein the characteristic of the first user includes identification data for the user.

38. The system of claim 20, wherein the characteristic of the data resource includes at least one content category type.

39. A computer program product for collecting usage data to assist an advertiser with a targeted marketing activity, comprising:
a computer readable medium;
program code in the computer readable medium for receiving a data resource from a communications network;
program code in the computer readable medium for storing the data resource;
program code in the computer readable medium for displaying the data resource for a first user;
program code in the computer readable medium for extracting usage data that relates a characteristic of the first user to a characteristic of the data resource; and
program code in the computer readable medium for storing the usage data,
wherein the advertiser accesses the usage data to determine an appropriate advertisement for a second user.

40. The computer program product of claim 39, wherein the data resource is not requested by the first user.

41. The computer program product of claim 39, further comprising:
program code in the computer readable medium for requesting the data resource.

42. The computer program product of claim 39, wherein the communications network is a broadcast data network.

43. The computer program product of claim 39, wherein the communications network is a hybrid network.

44. The computer program product of claim 43, wherein the hybrid network includes broadcast data and Internet data.

45. The computer program product of claim 44, wherein the broadcast data includes television broadcast data.

46. The computer program product of claim 45, wherein the television broadcast data includes digital video broadcast data, streaming video data, video-on-demand data, or near video-on-demand data.

47. The computer program product of claim 44, wherein the Internet data includes web page data, software download data, digital image data, music download data, video download data, radio station data, real-time music streaming, multimedia content data for books, magazines, or newspapers, or electronic commerce data.

48. The computer program product of claim 39, further comprising:
program code in the computer readable medium for creating a profile for a user; and
program code in the computer readable medium for storing the profile,
wherein the profile includes at least one content filtering requirement.

49. The computer program product of claim 48, wherein the data resource satisfies said at least one content filtering requirement.

50. The computer program product of claim 48, wherein said at least one content filtering requirement includes at least one content category type.

51. The computer program product of claim 48, wherein the program code in the computer readable medium stores the profile on a client computer.

52. The computer program product of claim 51, further comprising:
program code in the computer readable medium for uploading the profile from the client computer to a server computer connected to the client computer; and
program code in the computer readable medium for monitoring the communications network for said at least one content filtering requirement.

53. The computer program product of claim 48, wherein the program code in the computer readable medium for creating the profile further comprises:
program code in the computer readable medium for providing demographic data for the user; and
program code in the computer readable medium for selecting at least one content category type for the user to receive.

54. The computer program product of claim 48, wherein the program code in the computer readable medium for creating the profile further comprises:
program code in the computer readable medium for providing demographic data for the user; and
program code in the computer readable medium for selecting at least one content category type for the user to not receive.

55. The computer program product of claim 39, wherein a multimedia viewer or a web browser displays the data resource.

56. The computer program product of claim 39, wherein the characteristic of the first user includes identification data for the user.

57. The computer program product of claim 39, wherein the characteristic of the data resource includes at least one content category type.

58. A method for collecting usage data to assist an advertiser with a targeted marketing activity, comprising:
storing at least one content filtering requirement for a first user;
monitoring a communications network for a data resource that satisfies said at least one content filtering requirement;
storing the data resource;
displaying the data resource for the first user;
extracting usage data that relates a characteristic of the first user to a characteristic of the data resource; and
storing the usage data,
wherein the advertiser accesses the usage data to determine an appropriate advertisement for a second user.

59. The method of claim 58, wherein said at least one content filtering requirement includes at least one content category type.

60. The method of claim 59, wherein the monitoring of the communications network further comprises:
comparing a content category type for the data resource to said at least one content category type.

61. A system for collecting usage data to assist an advertiser with a targeted marketing activity, comprising:
a memory device; and
a processor disposed in communication with the memory device, the processor configured to:
store at least one content filtering requirement for a first user;
monitor a communications network for a data resource that satisfies said at least one content filtering requirement;
store the data resource;
display the data resource for the first user;
extract usage data that relates a characteristic of the first user to a characteristic of the data resource; and
store the usage data,
wherein the advertiser accesses the usage data to determine an appropriate advertisement for a second user.

62. The system of claim 61, wherein said at least one content filtering requirement includes at least one content category type.

63. The system of claim 62, wherein to monitor the communications network, the processor is further configured to:
compare a content category type for the data resource to said at least one content category type.

64. A computer program product for collecting usage data to assist an advertiser with a targeted marketing activity, comprising:
a computer readable medium;
program code in the computer readable medium for storing at least one content filtering requirement for a first user;
program code in the computer readable medium for monitoring a communications network for a data resource that satisfies said at least one content filtering requirement;
program code in the computer readable medium for storing the data resource;
program code in the computer readable medium for displaying the data resource for the first user;
program code in the computer readable medium for extracting usage data that relates a characteristic of the first user to a characteristic of the data resource; and
program code in the computer readable medium for storing the usage data, wherein the advertiser accesses the usage data to determine an appropriate advertisement for a second user.

65. The computer program product of claim 64, wherein said at least one content filtering requirement includes at least one content category type.

66. The computer program product of claim 65, wherein the program code in the computer readable medium for monitoring the communications network further comprises:
program code in the computer readable medium for comparing a content category type for the data resource to said at least one content category type.
